(19) United States
(12) Patent Application Publication
(10) Pub. No.: US 2025/0220709 A1
(43) Pub. Date: Jul. 3, 2025

(54) NETWORK ALLOCATION VECTOR PROTECTION IN A RELAY

(71) Applicant: Cisco Technology, Inc., San Jose, CA (US)

(72) Inventors: Matthew A. Silverman, Shaker Heights, OH (US); Brian D. Hart, Sunnyvale, CA (US); Malcolm M. Smith, Richardson, TX (US)

(73) Assignee: Cisco Technology, Inc., San Jose, CA (US)

(21) Appl. No.: 18/675,246

(22) Filed: May 28, 2024

Related U.S. Application Data
(60) Provisional application No. 63/616,571, filed on Dec. 30, 2023.

(51) Int. Cl. H04W 74/0816

(52) U.S. Cl. CPC H04W 74/0816

(57) ABSTRACT

Network Allocation Vector (NAV) protection in a relay may be provided. Providing NAV protection in a relay can include determining a frame sequence for sending a data signal to a destination Station (dSTA). A Multi-User Request to Send (MU-RTS) is transmitted, the MU-RTS comprising a MU-RTS user information field with a plurality of available bits, the plurality of available bits including one or more frame sequence bits of indicating the frame sequence. One or more Clear to Send (CTS) signals is received, and the data signal is transmitted in response to receiving the CTS. One or more acknowledge signals are received based on the frame sequence.

### RELATED APPLICATION

Under provisions of 35 U.S.C. § 119(e), Applicant claims the benefit of and priority to U.S. Provisional Application No. 63/616,571, filed Dec. 30, 2023, the disclosure of which is incorporated herein by reference in its entirety.

### TECHNICAL FIELD

The present disclosure relates generally to providing Network Allocation Vector (NAV) protection in a relay.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an example Multi-User Request to Send (MU-RTS) user information field for Network Allocation Vector (NAV) protection in a relay;

FIG. 2 is a block diagram of a first operating environment for NAV protection in a relay with a transmitting STA (tSTA) and a destination STA (dSTA) out of range of each other;

FIG. 3 is a block diagram of a second operating environment for NAV protection in a relay with the tSTA and the dSTA in range of each other;

FIG. 4 is a block diagram of a first frame sequence for NAV protection in a relay;

FIG. 5 is a block diagram of a second frame sequence for NAV protection in a relay;

FIG. 6 is a block diagram of a third frame sequence for NAV protection in a relay;

FIG. 7 is a block diagram of a fourth frame sequence for NAV protection in a relay;

FIG. 8 is a block diagram of a fifth frame sequence for NAV protection in a relay;

FIG. 9 is a flow chart of a method for NAV protection in a relay; and

FIG. 10 is a block diagram of a computing device.

### DETAILED DESCRIPTION

### Overview

Network Allocation Vector (NAV) protection in a relay may be provided. Providing NAV protection in a relay can include determining a frame sequence for sending a data signal to a destination Station (dSTA). A Multi-User Request to Send (MU-RTS) is transmitted, the MU-RTS comprising a MU-RTS user information field with a plurality of available bits, the plurality of available bits including one or more frame sequence bits of indicating the frame sequence. One or more Clear to Send (CTS) signals is received, and the data signal is transmitted in response to receiving the CTS. One or more acknowledge signals are received based on the frame sequence.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

One or more Access Points (APs) can be configured to communicate one or Stations (STAs), and an AP can transmit signals that carry information to the STAs. STAs can also transmit signals to the AP to send information. In some cases, an AP and/or a STA may use an intermediary device to relay signals to a desired destination. For example, a transmitting STA (tSTA), such as an AP or a client device, may transmit to a destination STA (dSTA) via a relay STA (rSTA) by transmitting the signal to the rSTA for the rSTA to transmit to the dSTA.

A device, such as the tSTA, the rSTA, and/or the dSTA, may utilize Network Allocation Vector (NAV) protection by setting its NAV in response to detecting a signal is being sent. For example, a frame may include (e.g., in Media Access Control (MAC) layer frame headers) a duration field that indicates the transmission time of the frame and therefore the period the channel will be busy). The device may use the duration field to set its NAV and not attempt to transmit during the period indicated by the NAV. Thus, the NAV indicates the duration a period will be busy, and a device can use the NAV to stay silent for the duration of a detected transmission.

When a transmitting device, such as the tSTA, sends a Request to Send (RTS) signal to request to send data, the receiving device may wait a Short Interframe Space (SIFS) before sending a Clear to Send (CTS) signal indicating that the transmitting device can send the data. The original transmitting device may then wait another SIFS before sending the data. Once the receiving device receives the data, the receiving device will again wait a SIFS before sending an Acknowledge (ACK) signal. Devices that detect the signals being transmitted may set their NAV to avoid transmitting during the RTS, CTS, data, and/or ACK signals. For example, the devices may set their NAV to the duration from the RTS signal to the ending of the ACK, to the first SIFS before sending the CTS signal to the ending of ACK, and/or the like.

In a relay, the dSTA may be in range of tSTA, or the dSTA may not be able to consistently hear RTS signals from the tSTA or successfully send CTS signals to the tSTA. For both scenarios, NAV protection methods across all Radio Frequency (RF) domains of each device are described herein. For example, NAV protection is provided in a relay to all devices by creating new MAC sequences of RTS, CTS, Physical Layer Protocol Data Unit (PPDU), and Block ACK (BA) signals. Additionally, for a low-latency case, RTS and CTS signal modifications are described so both signals can be transmitted in the same Transmit Opportunity (TxOp). Devices may set their NAVs so they can defer transmitting during the TxOp.

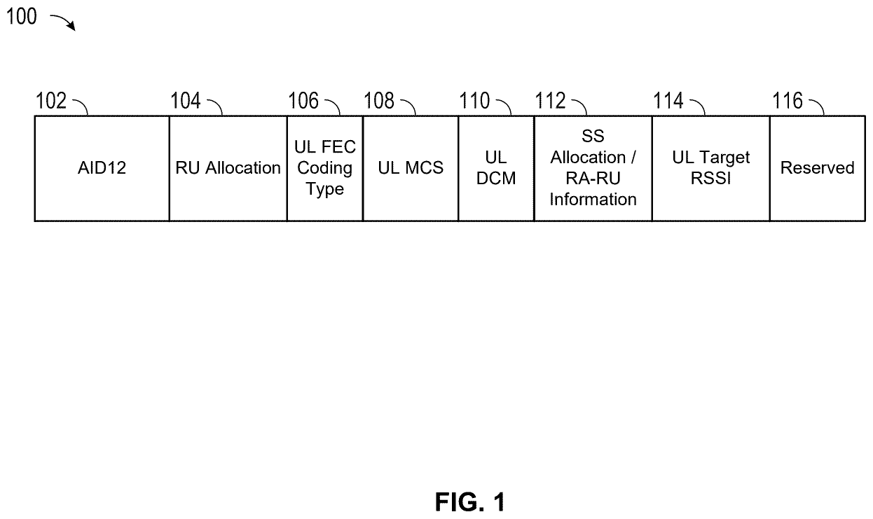

FIG. 1 is a block diagram of an example Multi-User Request to Send (MU-RTS) user information field 100 for NAV protection in a relay. A MU-RTS may be used to elicit a CTS response from at least one MU capable STAs addressed in the MU-RTS frame. The MU-RTS user information field 100 may include an Association ID (AID) field 102, a Resource Unit (RU) allocation field 104, a first unused field 106, a second unused field 108, a third unused field 110, a fourth unused field 112, a fifth unused field 114, and a reserved field 116. There may be other fields in other examples, such as a variable length field for trigger dependent user information. The AID field 102 may indicate the ID of intended recipient STA, and the RU allocation field may identify which channel the CTS response should be sent on. In some embodiments, the first unused field 106 may be an Upload (UL) Forward Area Correction Code field, the second unused field 108 may be an UL Modulation and Coding Scheme field, the third unused field 110 may be an UL Dual Carrier Modulation field, the fourth unused field 112 may be a Spatial Stream Allocation and Resource Allocation-RU information field, and the fifth unused field 114 may be a UL target Received Signal Strength Indicator (RSSI) field.

The first unused field 106, the second unused field 108, the third unused field 110, the fourth unused field 112, the fifth unused field 114, and/or the reserved field 116 may be utilized for NAV protection in a relay, because the fields may not be used for typical or otherwise existing MU-RTS purposes. In some embodiments, the first unused field 106 has one bit, the second unused field 108 has four bits, the third unused field 110 has one bit, the fourth unused field 112 has six bits, the fifth unused field 114 has seven bits, and the reserved field 116 has one bit. Therefore, there may be twenty available bits in the MU-RTS user information field 100 for NAV protection, including the bit of the reserved field 116.

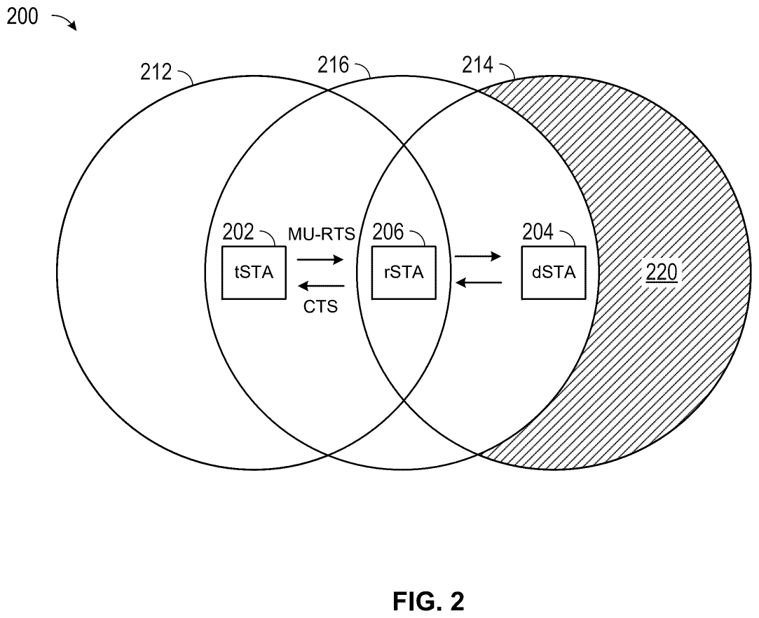

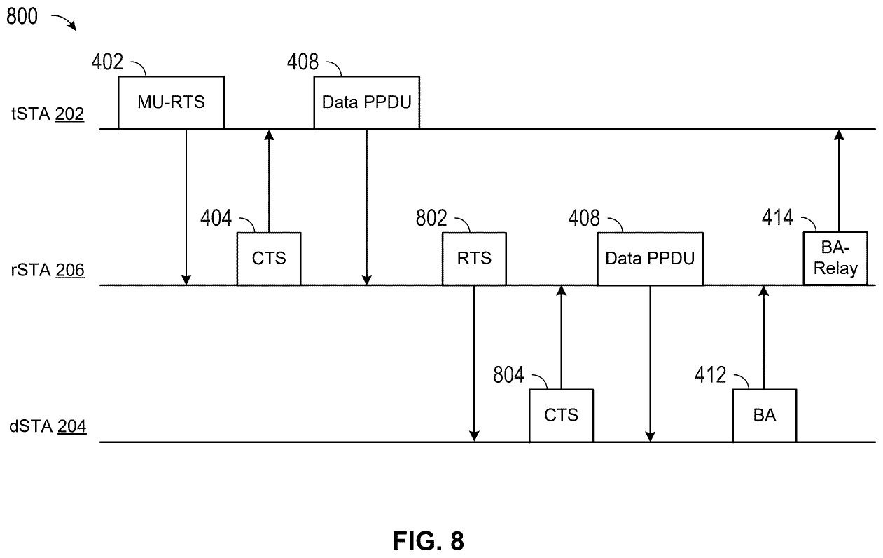

FIG. 2 is a block diagram of a first operating environment 200 for NAV protection in a relay with a tSTA 202 and a dSTA 204 out of range of each other. The first operating environment 200 also includes a rSTA 206. The tSTA 202 may have a tSTA range 212 indicating the range at which the tSTA 202 can reliably communicate (i.e., RF range). Similarly, the dSTA 204 may have a dSTA range 214, and the rSTA 206 may have a rSTA range 216. The tSTA 202 is outside of the dSTA range 214, and the dSTA 204 is outside of the tSTA range 212. Therefore, the tSTA 202 and the dSTA 204 may not be able to communicate directly in the first operating environment 200. The rSTA 206 may therefore relay communications between the tSTA 202 and the dSTA 204. Because of the relaying, communications between the tSTA 202 and the dSTA 204 may occur in separate TxOps, resulting in a loss of low-latency operation and/or risking collision from STAs in an unprotected region 220. However, example frame sequences for completing the communications in a single TxOp are described herein with respect to FIG. 8 to maintain low latency operation and avoid collisions from STAs in the unprotected region 220.

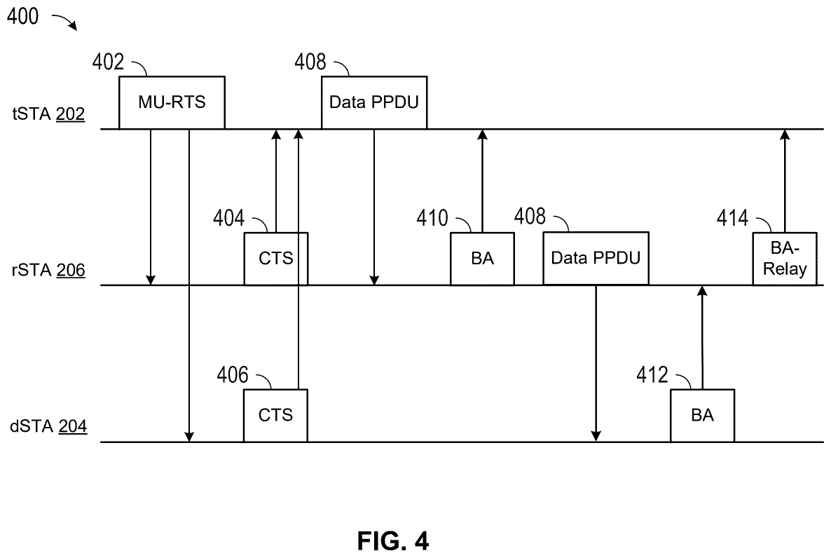

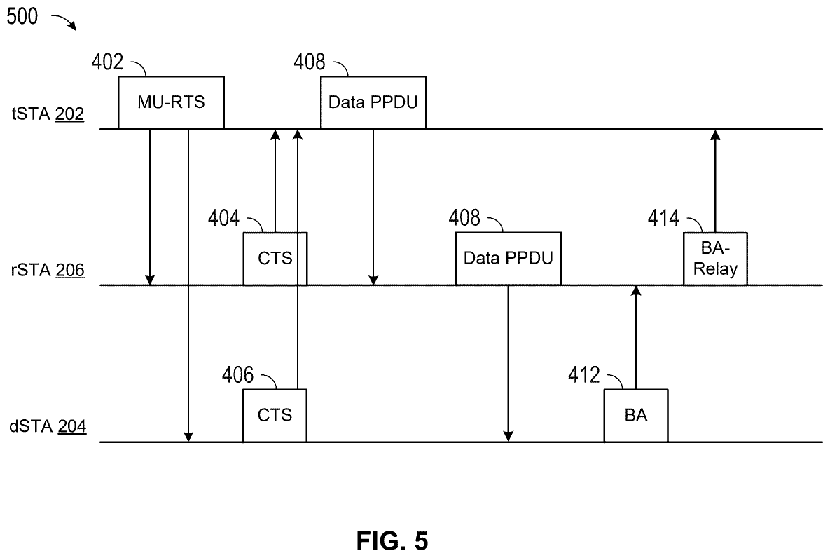

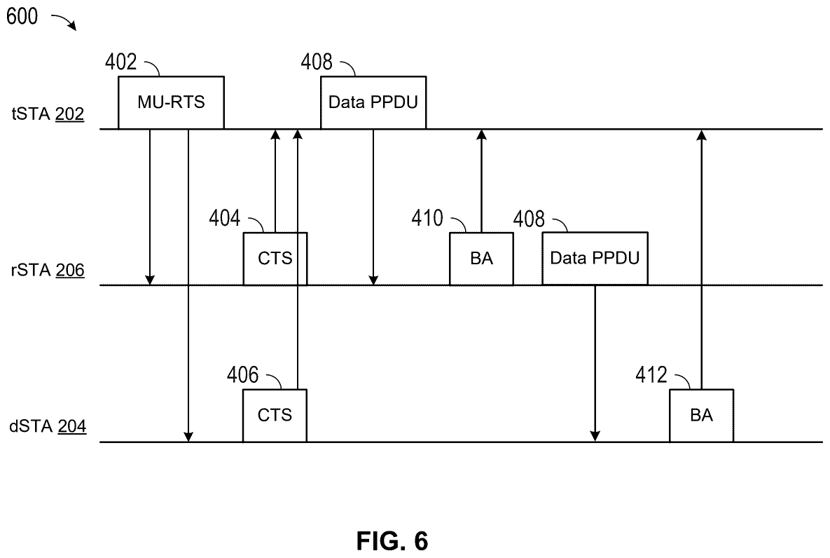

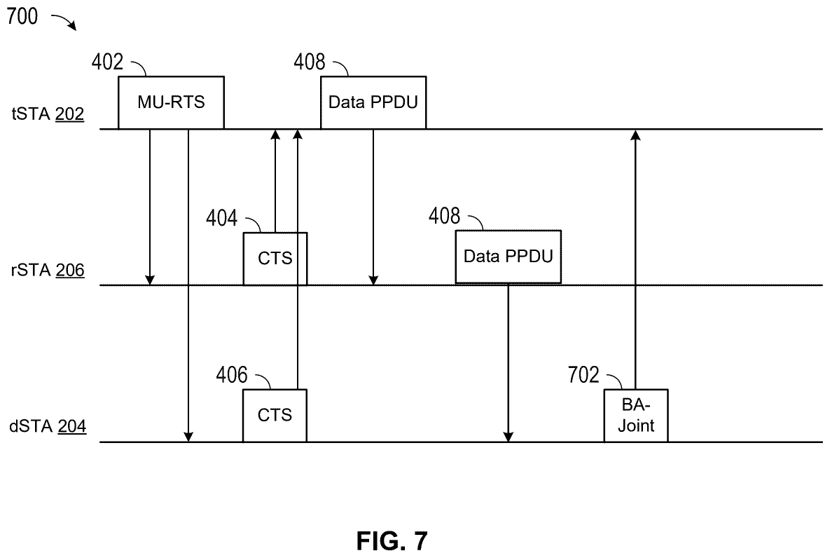

In the first operating environment 200, the tSTA 202 may send a MU-RTS, including the MU-RTS user information field 100. The tSTA 202 may use one of the available bits to indicate to the rSTA 206 that it is to act as a relay during the TxOp. In some embodiments, the tSTA 202 may use multiple available bits (e.g., twelve bits) to indicate the partial AID of the dSTA 204. In other embodiments, the tSTA 202 may use multiple available bits to indicate the index of a user info field that has the full dSTA 204 user info to use fewer available bits compared to indicate the partial AID. Finally, the tSTA 202 may use one or more available bits to indicate the frame sequence (e.g., BA plan) to use for the TxOp so that the rSTA 206 and/or the dSTA 204 knows which frame sequence is performed. Various frame sequences will be described herein with respect to FIG. 4, FIG. 5, FIG. 6, FIG. 7, and FIG. 8.

In some embodiments, the dSTA 204 may know info associated with the rSTA 206, so the dSTA 204 does not need a pointer to the user info of the dSTA 204 (i.e., as indicated in the MU-RTS user information field 100). However, if the tSTA 202 and the dSTA 204 setup multiple rSTAs (e.g., for redundancy), the dSTA 204 can snoop each rSTA's user info to identify the user info of the dSTA 204. Since a MU-RTS may protect traffic to multiple users (e.g., Orthogonal Frequency-Division Multiple Access (OFDMA) where the rSTA 206 is just one of the users) then the dSTA user info might include the Partial AID of the rSTA 206 or the index for the user info field of the dSTA 204 (i.e., as indicated in the MU-RTS user information field 100) in the MU-RTS. Additionally, one bit may indicate to the dSTA 204 that is the destination in this TxOp, so the dSTA 204 could also be directly transmitted to if it is possible and the tSTA 202 chooses to do so. One or more bits may be used to indicate the frame sequence for the TxOp so that the dSTA 204 knows which frame sequence is performed.

Thus, the available bits may include relay bits to indicate the rSTA 206 is a relay, destination bits to indicate the dSTA 204 is the destination, relay ID bits to indicate a partial AID or some other ID of the rSTA 206 (e.g., pointer to the index for the user info field of the rSTA 206), destination ID bits to indicate a partial AID or some other ID of the dSTA 204 (e.g., pointer to the index for the user info field of the dSTA 204), frame sequence bits to indicate which frame sequence to perform, and/or the like. Depending on the number of bits needed to convey the information, the relay bits, the destination bits, the relay ID bits, the destination ID bits, the frame sequence bits, and/or the like may be one or more bits.

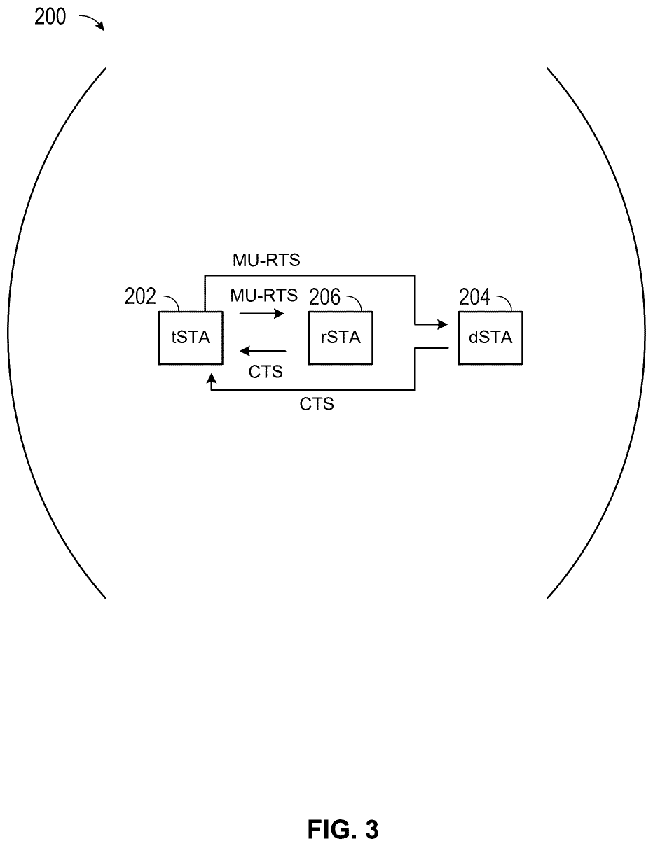

FIG. 3 is a block diagram of a second operating environment 300 for NAV protection in a relay with the tSTA 202 and the dSTA 204 in range of each other. Because the tSTA 202 and the dSTA 204 can communicate directly in the second operating environment 300, the tSTA 202 can send a MU-RTS with the MU-RTS user information field 100 to the rSTA 206 and the dSTA 204. The tSTA 202 may use the available bits of the MU-RTS user information field 100 as described above (e.g., to indicate partial AID of the dSTA 204, to indicate partial AID of the rSTA 206, to point to the index for the user info field of the dSTA 204, to point to the index for the user info field of the rSTA 206, to indicate the relay and destination, to indicate which frame sequence to perform, etc.). Because the tSTA 202 and the dSTA 204 may directly communicate, the communications may occur in a single TxOp, resulting in low-latency operation without risking collision from STAs in the unprotected region 220 (i.e., all RF domains are protected).

Because the tSTA 202 and the dSTA 204 may be out of range of each other in some scenarios and in range of each other in other scenarios, there are two cases that need to be defined for NAV protection. The first scenario is where the tSTA 202 and the dSTA 204 can directly communicate the MU-RTS and CTS signals as shown in the second operating environment 300. The second scenario is where the tSTA 202 and the dSTA 204 cannot directly communicate the MU-RTS and CTS signals as shown in the first operating environment 200. FIG. 4, FIG. 5, FIG. 6, and FIG. 7 may illustrate example frame sequences for the first scenario where the tSTA 202 and the dSTA 204 can directly communicate the MU-RTS and CTS signals. FIG. 8 may illustrate an example frame sequence for the second scenario where the tSTA 202 and the dSTA 204 cannot directly communicate the MU-RTS and CTS signals. As discussed above, the tSTA 202 may indicate in the MU-RTS user information field 100 which frame sequence to use.

FIG. 4 is a block diagram of a first frame sequence 400 for NAV protection in a relay. The tSTA 202 may use the first frame sequence 400 to use a full relay procedure in a single TxOp. The tSTA 202 and the dSTA 204 may be within range of each other (e.g., such as in the second operating environment 300) and can communicate directly for at least for some signals. For example, the tSTA 202 and the dSTA 204 may be able to complete the RTS and CTS signaling process but need to use the rSTA 206 to relay data such as via a PPDU. The tSTA 202 and the dSTA 204 may utilize completing the RTS and CTS signaling process directly so first frame sequence 400 can be a single TxOp. Therefore, NAV durations may be set for the duration of the TxOp, the duration of the first frame sequence 400, and the like.

The first frame sequence 400 may begin with the tSTA 202 transmitting a MU-RTS 402 to the rSTA 206 and/or the dSTA 204 to request to send data to the dSTA 204. The MU-RTS 402 may include a MU-RTS user information field 100, and the tSTA 202 may use the available bits of the MU-RTS user information field 100 to indicate the rSTA 206 is to act as a relay during the TxOp, the dSTA 204 is the destination, the partial AID of the dSTA 204, the partial AID of the rSTA 206, the index of a user info field that has the full dSTA 204, the frame sequence for the TxOp so that the rSTA 206 and/or the dSTA 204 knows the first frame sequence 400 is to be performed, and/or the like. The dSTA 204 may be able to receive the MU-RTS 402 and recognize that the MU-RTS 402 is a RTS signal and therefore know to respond with a CTS signal. In some embodiments, the rSTA 206 may need to relay the MU-RTS 402 so the dSTA 204 can identify the information in the MU-RTS user information field 100.

Next, the rSTA 206 may send a rSTA CTS signal 404 simultaneously with the dSTA 204 sending a dSTA CTS signal 406 to the tSTA 202 to indicate the tSTA 202 can send the data. The dSTA 204 may be able to send the dSTA CTS signal 406 directly to the tSTA 202. Once the tSTA 202 receives the rSTA CTS signal 404 and the dSTA CTS signal 406, the tSTA 202 may send a data signal 408 to the rSTA 206. The data signal 408 may be a PPDU containing data the tSTA 202 determines to send before initiating the first frame sequence 400.

Once the rSTA 206 receives the data signal 408, the rSTA 206 may send a rSTA BA signal 410 to the tSTA 202 acknowledging the reception of the data signal 408. The rSTA 206 may relay the data signal 408 to the dSTA 204, and the dSTA 204 may send a dSTA BA 412 to the rSTA 206 to acknowledge that the dSTA 204 received the data signal 408. Finally, the rSTA 206 may send a relay BA 414 to the tSTA 202 acknowledging that the relay of the data signal 408 to the dSTA 204 is complete.

In the first frame sequence 400, there may be a SIFS between the transmissions. For example, there may be a SIFS between the MU-RTS 402 and the rSTA CTS signal 404, between the MU-RTS 402 and the dSTA CTS signal 406, a SIFS before the data signal 408, and the like. A SIFS may be the period the tSTA 202, the dSTA 204, and the rSTA 206 request or need to process a received frame and respond.

NAV durations may be set in response to detecting the MU-RTS 402, detecting the rSTA CTS signal 404, detecting the dSTA CTS signal 406, and/or the like.

FIG. 5 is a block diagram of a second frame sequence 500 for NAV protection in a relay. The tSTA 202 may use the second frame sequence 500 to use a full relay in single TxOp with a single BA that carries both the rSTA 206 and the dSTA 204 ACKs at the end of the second frame sequence 500. The second frame sequence 500 may be completed in a shorter period compared to the first frame sequence 400 with one fewer BA required, therefore reducing channel usage.

The tSTA 202 and the dSTA 204 may be within range of each other and, the tSTA 202 and the dSTA 204 may be able to complete the RTS and CTS signaling process but need to use the rSTA 206 to relay data. The tSTA 202 and the dSTA 204 may utilize completing the RTS and CTS signaling process directly so the second frame sequence 500 can be a single TxOp. Therefore, NAV durations may be set for the duration of the TxOp, the duration of the second frame sequence 500, and the like.

The second frame sequence 500 may begin with the tSTA 202 transmitting a MU-RTS 402 to the rSTA 206 and/or the dSTA 204 to request to send data to the dSTA 204. The MU-RTS 402 may include a MU-RTS user information field 100, and the tSTA 202 may use the available bits of the MU-RTS user information field 100 to convey information as described above. The dSTA 204 may be able to receive the MU-RTS 402 and recognize that the MU-RTS 402 is a RTS signal and therefore know to respond with a CTS signal.

The rSTA 206 may next send a rSTA CTS signal 404 to the tSTA 202 simultaneously with the dSTA 204 sending a dSTA CTS signal 406 to the tSTA 202 to indicate the tSTA 202 can send the data. The dSTA 204 may be able to send the dSTA CTS signal 406 directly to the tSTA 202. Once the tSTA 202 receives the rSTA CTS signal 404 and the dSTA CTS signal 406, the tSTA 202 may send a data signal 408 to the rSTA 206. The data signal 408 may be a PPDU containing data the tSTA 202 determines to send before initiating the second frame sequence 500.

Once the rSTA 206 receives the data signal 408, the rSTA 206 may relay the data signal 408 to the dSTA 204 without sending a rSTA BA signal 410 to the tSTA 202. The tSTA 202 may instruct the rSTA 206 and the dSTA 204 to operate according to the second frame sequence 500, so the tSTA 202 will be aware that the rSTA 206 will not send a rSTA BA signal 410 in response to receiving the data signal 408. After the dSTA 204 receives the data signal 408, the dSTA 204 may send a dSTA BA 412 to the rSTA 206 to acknowledge that the dSTA 204 received the data signal 408. The rSTA 206 may lastly send a relay BA 414 to the tSTA 202 acknowledging that the relay of the data signal 408 to the dSTA 204 is complete.

In the second frame sequence 500, there may be a SIFS between the transmissions. For example, there may be a SIFS between the MU-RTS 402 and the rSTA CTS signal 404, between the MU-RTS 402 and the dSTA CTS signal 406, a SIFS before the data signal 408, and the like. NAV durations may be set in response to detecting the MU-RTS 402, detecting the rSTA CTS signal 404, detecting the dSTA CTS signal 406, and/or the like.

FIG. 6 is a block diagram of a third frame sequence 600 for NAV protection in a relay. The tSTA 202 may use the third frame sequence 600 to use a full relay in single TxOp with directly communicated BAs. For example, the third frame sequence 600 may be used when the dSTA 204 can directly transmit a BA to the tSTA 202 (e.g., in the second operating environment 300). The third frame sequence 600 may be completed in a shorter period compared to the first frame sequence 400 with one fewer BA required, therefore reducing channel usage.

The tSTA 202 and the dSTA 204 may be within range of each other and, the tSTA 202 and the dSTA 204 may be able to complete the RTS, CTS, and BA signaling processes but need to use the rSTA 206 to relay data. The tSTA 202 and the dSTA 204 may utilize completing the RTS, CTS, and BA signaling processes directly so the third frame sequence 600 can be a single TxOp. Therefore, NAV durations may be set for the duration of the TxOp, the duration of the third frame sequence 600, and the like.

The third frame sequence 600 may begin with the tSTA 202 transmitting a MU-RTS 402 to the rSTA 206 and/or the dSTA 204 to request to send data to the dSTA 204. The MU-RTS 402 may include a MU-RTS user information field 100, and the tSTA 202 may use the available bits of the MU-RTS user information field 100 to convey information as described above. The dSTA 204 may be able to receive the MU-RTS 402 and recognize that the MU-RTS 402 is a RTS signal and therefore know to respond with a CTS signal.

The rSTA 206 may thereafter send a rSTA CTS signal 404 to the tSTA 202 simultaneously with the dSTA 204 sending a dSTA CTS signal 406 to the tSTA 202 to indicate the tSTA 202 can send the data. The dSTA 204 may be able to send the dSTA CTS signal 406 directly to the tSTA 202. When the tSTA 202 receives the rSTA CTS signal 404 and the dSTA CTS signal 406, the tSTA 202 may send a data signal 408 to the rSTA 206. The data signal 408 may be a PPDU containing data the tSTA 202 determines to send before initiating the third frame sequence 600.

Once the rSTA 206 receives the data signal 408, the rSTA 206 may send a rSTA BA signal 410 to the tSTA 202 acknowledging the reception of the data signal 408. The rSTA 206 may then relay the data signal 408 to the dSTA 204. After the dSTA 204 receives the data signal 408, the dSTA 204 may send a dSTA BA 412 directly to the tSTA 202 to acknowledge that the dSTA 204 received the data signal 408. The dSTA 204 may be able to directly send the dSTA BA 412 to the tSTA 202 in the third frame sequence 600, therefore avoiding the necessity of the rSTA 206 sending a relay BA 414.

In the third frame sequence 600, there may be a SIFS between the transmissions. For example, there may be a SIFS between the MU-RTS 402 and the rSTA CTS signal 404, between the MU-RTS 402 and the dSTA CTS signal 406, a SIFS before the data signal 408, and the like. NAV durations may be set in response to detecting the MU-RTS 402, detecting the rSTA CTS signal 404, detecting the dSTA CTS signal 406, and/or the like.

FIG. 7 is a block diagram of a fourth frame sequence 700 for NAV protection in a relay. The tSTA 202 may use the fourth frame sequence 700 to use a full relay in single TxOp with a single joint BA 702 that carries both the rSTA 206 and the dSTA 204 ACKs at the end of the fourth frame sequence 700 for an end-to-end BA process. The fourth frame sequence 700 may be completed in a shorter period compared to the first frame sequence 400 with two fewer BAs required and shorter than the second frame sequence 500 and the third frame sequence 600 with one fewer BA required, thereby reducing channel usage.

The tSTA 202 and the dSTA 204 may be within range of each other and, the tSTA 202 and the dSTA 204 may be able to complete the RTS, CTS, and BA signaling processes but need to use the rSTA 206 to relay data. The tSTA 202 and the dSTA 204 may utilize completing the RTS, CTS, and BA signaling process directly so the fourth frame sequence 700 can be a single TxOp. Therefore, NAV durations may be set for the duration of the TxOp, the duration of the fourth frame sequence 700, and the like.

The fourth frame sequence 700 may begin with the tSTA 202 transmitting a MU-RTS 402 to the rSTA 206 and/or the dSTA 204 to request to send data to the dSTA 204. The MU-RTS 402 may include a MU-RTS user information field 100, and the tSTA 202 may use the available bits of the MU-RTS user information field 100 to convey information as described above. The dSTA 204 may be able to receive the MU-RTS 402 and recognize that the MU-RTS 402 is a RTS signal and therefore know to respond with a CTS signal.

The rSTA 206 may next send a rSTA CTS signal 404 to the tSTA 202 simultaneously with the dSTA 204 sending a dSTA CTS signal 406 to the tSTA 202 to indicate the tSTA 202 can send the data. The dSTA 204 may be able to send the dSTA CTS signal 406 directly to the tSTA 202. Once the tSTA 202 receives the rSTA CTS signal 404 and the dSTA CTS signal 406, the tSTA 202 may send a data signal 408 to the rSTA 206. The data signal 408 may be a PPDU containing data the tSTA 202 determines to send before initiating the second frame sequence 500.

When the rSTA 206 receives the data signal 408, the rSTA 206 may relay the data signal 408 to the dSTA 204 without sending a rSTA BA signal 410. After the dSTA 204 receives the data signal 408, the dSTA 204 may send a joint BA 702 directly to the tSTA 202 to acknowledge that the rSTA 206 received the data signal 408 and the rSTA 206 relayed the data signal 408 to the dSTA 204. The dSTA 204 may be able to directly send the joint BA 702 to the tSTA 202 in the fourth frame sequence 700, therefore avoiding the necessity of the rSTA 206 sending a rSTA BA 401 and a relay BA 414 and the dSTA 204 sending a standalone dSTA BA 412.

In the fourth frame sequence 700, there may be a SIFS between the transmissions. For example, there may be a SIFS between the MU-RTS 402 and the rSTA CTS signal 404, between the MU-RTS 402 and the dSTA CTS signal 406, a SIFS before the data signal 408, and the like. NAV durations may be set in response to detecting the MU-RTS 402, detecting the rSTA CTS signal 404, detecting the dSTA CTS signal 406, and/or the like.

FIG. 8 is a block diagram of a fifth frame sequence 800 for NAV protection in a relay. The tSTA 202 may use the fifth frame sequence 800 when the tSTA 202 and the dSTA 204 are out of range and cannot directly communicate any signals. The tSTA 202 and the dSTA 204 may utilize the rSTA 206 so the fifth frame sequence 800 can be a single TxOp. For example, the tSTA 202 may send data without waiting for a CTS signal and wait for a relay BA 414 at the end of the fifth frame sequence 800 to fit the fifth frame sequence 800 in a single TxOp. NAV durations may thus be set for the duration of the TxOp, the duration of the third frame sequence 600, and the like.

The fifth frame sequence 800 may begin with the tSTA 202 transmitting a MU-RTS 402 to the rSTA 206 to request to send data to the dSTA 204 via the rSTA 206. The MU-RTS 402 may include a MU-RTS user information field 100, and the tSTA 202 may use the available bits of the MU-RTS user information field 100 to convey information as described above.

Next, the rSTA 206 may send a rSTA CTS signal 404 to the tSTA 202 to indicate the tSTA 202 can send the data. Once the tSTA 202 receives the rSTA CTS signal 404, the tSTA 202 may send a data signal 408 to the rSTA 206. The data signal 408 may be a PPDU containing data the tSTA 202 determines to send before initiating the fifth frame sequence 800.

The rSTA 206 may send a relay RTS 802 to the dSTA 204 after receiving the data signal 408. The relay RTS 802 may include at least a portion of the information included in the MU-RTS user information field 100 of the MU-RTS 402. When the dSTA 204 receives the relay RTS 802, the dSTA 204 can reply with a relay CTS signal 804 to the rSTA 206. The relay CTS signal 804 may indicate that the rSTA 206 can send the data signal 408 to the dSTA 204.

The rSTA 206 may relay the data signal 408 to the dSTA 204 after receiving the relay CTS signal 804. In response, the dSTA 204 may send a dSTA BA 412 to the rSTA 206. Finally, the rSTA 206 may transmit a relay BA 414 to the tSTA 202.

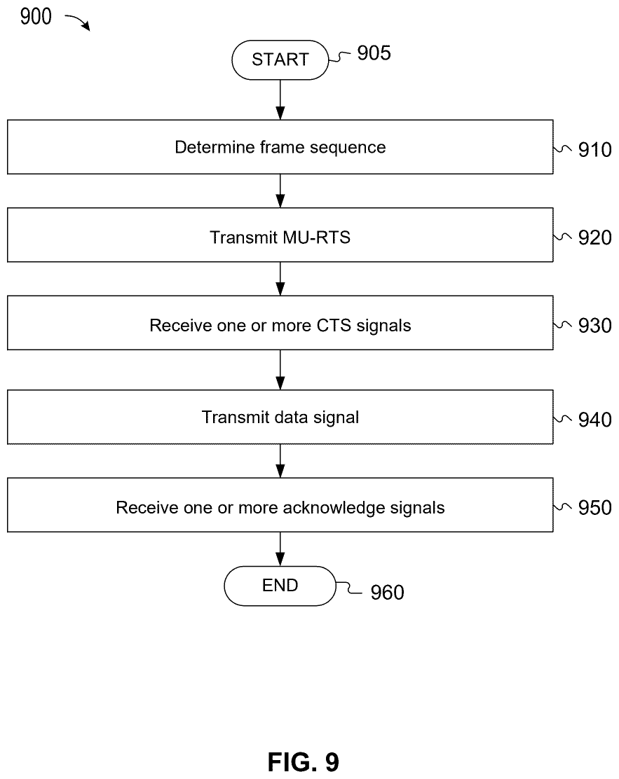

FIG. 9 is a flow chart of a method 900 for NAV protection in a relay. The method 900 may begin at starting block 905 and proceed to operation 910. In operation 910, a frame sequence for sending a data signal to a dSTA is determined. For example, the tSTA 202 determine the frame sequence based at least in part on whether the tSTA 202 can directly communicate with the dSTA 204. The frame sequence may be the first frame sequence 400, the second frame sequence 500, the third frame sequence 600, the fourth frame sequence 700, or the fifth frame sequence 800.

In operation 920, a MU-RTS is transmitted. For example, the tSTA 202 transmits a MU-RTS 402 comprising a MU-RTS user information field 100. The MU-RTS user information field 100 can include a plurality of available bits, and the plurality of available bits can include one or more frame sequence bits of indicating the frame sequence. The available bits can also include one or more relay ID bits indicating a relay ID of the rSTA 206, one or more relay bits indicating the rSTA 206 to act as a relay, one or more destination ID bits indicating a dSTA ID of the dSTA 204, one or more destination bits indicating the dSTA 204 is a destination for the data signal 408, and/or the like.

In operation 930, one or more Clear to Send (CTS) signals is received. For example, the tSTA 202 may receive a rSTA CTS signal 404 and/or a dSTA CTS signal 406. The tSTA 202 may only receive the dSTA CTS signal 406 when the tSTA 202 and the dSTA 204 can directly communicate.

In operation 940, the data signal is transmitted in response to receiving the CTS. For example, the tSTA 202 transmits the data signal 408 to the rSTA 206. The rSTA 206 may subsequently relay the data signal 408 to the dSTA 204.

In operation 950, one or more acknowledge signals are received based on the frame sequence. For example, the tSTA 202 receives one or more of a rSTA BA signal 410, a dSTA BA 412, a relay BA 414, and/or a joint BA 702 based on whether the frame sequence is first frame sequence 400, the second frame sequence 500, the third frame sequence 600, the fourth frame sequence 700, or the fifth frame sequence 800. The tSTA 202 may receive the one or more acknowledge signals in the order of operations of the frame sequence. The method 900 may conclude at ending block 960.

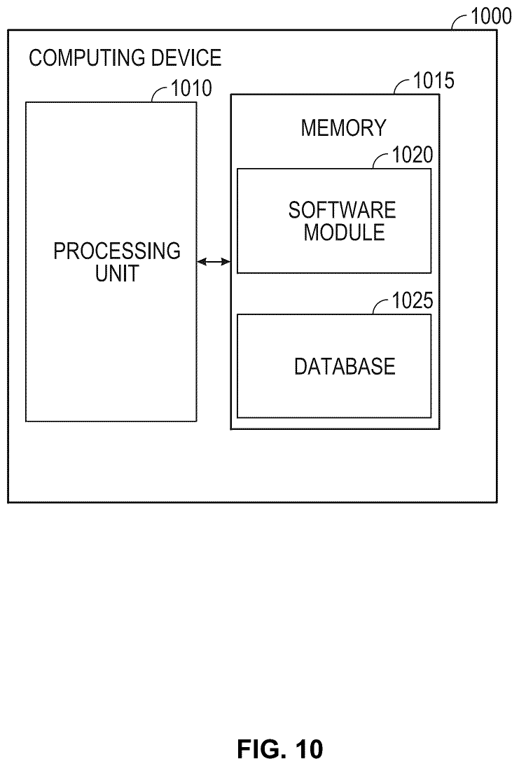

FIG. 10 is a block diagram of a computing device 1000. As shown in FIG. 10, computing device 1000 may include a processing unit 1010 and a memory unit 1015. Memory unit 1015 may include a software module 1020 and a database 1025. While executing on processing unit 1010, software module 1020 may perform, for example, processes for NAV protection in a relay with respect to FIG. 1, FIG. 2, FIG. 3, FIG. 4, FIG. 5, FIG. 6, FIG. 7, FIG. 8, and FIG. 9. Computing device 1000, for example, may provide an operating environment for the tSTA 202, the dSTA 204, the rSTA 206, and the like. The tSTA 202, the dSTA 204, the rSTA 206, and the like may operate in other environments and are not limited to computing device 1000.

Computing device 1000 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1000 may comprise any computer operating environment, such as hand-held devices, multiprocessor systems, microprocessor-based or programmable sender electronic devices, minicomputers, mainframe computers, and the like. Computing device 1000 may also be practiced in distributed computing environments where tasks are performed by remote processing devices. The aforementioned systems and devices are examples, and computing device 1000 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1000 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining a frame sequence for sending a data signal to a destination Station (dSTA);
transmitting a Multi-User Request to Send (MU-RTS), the MU-RTS comprising a MU-RTS user information field with a plurality of available bits, the plurality of available bits including one or more frame sequence bits of indicating the frame sequence;
receiving one or more Clear to Send (CTS) signals;
transmitting the data signal in response to receiving the CTS; and
receiving one or more acknowledge signals based on the frame sequence.

2. The method of claim 1, wherein the plurality of available bits further comprise any one of (i) one or more relay ID bits indicating a relay ID of a relay Station (rSTA), (ii) one or more relay bits indicating the rSTA to act as a relay, (iii) one or more destination ID bits indicating a dSTA ID of the dSTA, (iv) one or more destination bits indicating the dSTA is a destination for the data signal, or (v) any combination of (i)-(iv).

3. The method of claim 1, wherein:
transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises:
receiving a rSTA Block Acknowledge (BA) from the rSTA after transmitting the data signal to the rSTA, and
receiving a relay BA from the rSTA after the rSTA sends the data signal to the dSTA and receives a dSTA BA from the dSTA.

4. The method of claim 1, wherein:
transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises receiving a relay BA from the rSTA after the rSTA sends the data signal to the dSTA and receives a dSTA BA from the dSTA.

5. The method of claim 1, wherein:
transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises:
receiving a rSTA BA from the rSTA after transmitting the data signal to the rSTA, and
receiving a dSTA BA from the dSTA after the rSTA sends the data signal to the dSTA.

6. The method of claim 1, wherein:
transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises: receiving a joint BA from the dSTA after the rSTA sends the data signal to the dSTA.

7. The method of claim 1, wherein:
transmitting the MU-RTS comprises transmitting the MU-RTS to the rSTA;
receiving the one or more CTS signals comprises receiving a rSTA CTS signal from the rSTA;
transmitting the data signal comprises transmitting the data signal to the rSTA; and
receiving the one or more acknowledge signals comprises receiving a relay BA from the rSTA after the rSTA sends a relay RTS to the dSTA, receives a relay CTS from the dSTA, sends the data signal to the dSTA, and receives a dSTA BA from the dSTA.

8. A system comprising:
a memory storage; and
a processing unit coupled to the memory storage, wherein the processing unit is operative to:
determine a frame sequence for sending a data signal to a destination Station (dSTA);
transmit a Multi-User Request to Send (MU-RTS), the MU-RTS comprising a MU-RTS user information field with a plurality of available bits, the plurality of available bits including one or more frame sequence bits of indicating the frame sequence;
receive one or more Clear to Send (CTS) signals;
transmit the data signal in response to receiving the CTS; and
receive one or more acknowledge signals based on the frame sequence.

9. The system of claim 8, wherein the plurality of available bits further comprise any one of (i) one or more relay ID bits indicating a relay ID of a relay Station (rSTA), (ii) one or more relay bits indicating the rSTA to act as a relay, (iii) one or more destination ID bits indicating a dSTA ID of the dSTA, (iv) one or more destination bits indicating the dSTA is a destination for the data signal, or (v) any combination of (i)-(iv).

10. The system of claim 8, wherein:
to transmit the MU-RTS comprises to transmit the MU-RTS to the rSTA and the dSTA;
to receive the one or more CTS signals comprises to receive a rSTA CTS signal from the rSTA and a dSTA CTS signal from the dSTA;
to transmit the data signal comprises to transmit the data signal to the rSTA; and
to receive the one or more acknowledge signals comprises to:
receive a rSTA Block Acknowledge (BA) from the rSTA after transmitting the data signal to the rSTA, and
receive a relay BA from the rSTA after the rSTA sends the data signal to the dSTA and receives a dSTA BA from the dSTA.

11. The system of claim 8, wherein:
to transmit the MU-RTS comprises to transmit the MU-RTS to the rSTA and the dSTA;
to receive the one or more CTS signals comprises to receive a rSTA CTS signal from the rSTA and a dSTA CTS signal from the dSTA;
to transmit the data signal comprises to transmit the data signal to the rSTA; and
to receive the one or more acknowledge signals comprises to:
receive a rSTA Block Acknowledge (BA) from the rSTA after transmitting the data signal to the rSTA, and
receive a relay BA from the rSTA after the rSTA sends the data signal to the dSTA and receives a dSTA BA from the dSTA.

12. The system of claim 8, wherein:
to transmit the MU-RTS comprises to transmit the MU-RTS to the rSTA and the dSTA;
to receive the one or more CTS signals comprises to receive a rSTA CTS signal from the rSTA and a dSTA CTS signal from the dSTA;
to transmit the data signal comprises to transmit the data signal to the rSTA; and
to receive the one or more acknowledge signals comprises to receive a relay BA from the rSTA after the rSTA sends the data signal to the dSTA and receives a dSTA BA from the dSTA.

13. The system of claim 8, wherein:
to transmit the MU-RTS comprises to transmit the MU-RTS to the rSTA and the dSTA;
to receive the one or more CTS signals comprises to receive a rSTA CTS signal from the rSTA and a dSTA CTS signal from the dSTA;
to transmit the data signal comprises to transmit the data signal to the rSTA; and
to receive the one or more acknowledge signals comprises to:
receive a rSTA BA from the rSTA after transmitting the data signal to the rSTA, and
receive a dSTA BA from the dSTA after the rSTA sends the data signal to the dSTA.

14. The system of claim 8, wherein:
to transmit the MU-RTS comprises to transmit the MU-RTS to the rSTA;
to receive the one or more CTS signals comprises to receive a rSTA CTS signal from the rSTA;
to transmit the data signal comprises to transmit the data signal to the rSTA; and
to receive the one or more acknowledge signals comprises to receive a relay BA from the rSTA after the rSTA sends a relay RTS to the dSTA, receives a relay CTS from the dSTA, sends the data signal to the dSTA, and receives a dSTA BA from the dSTA.

15. A non-transitory computer-readable medium that stores a set of instructions which when executed perform a method executed by the set of instructions comprising:
determining a frame sequence for sending a data signal to a destination Station (dSTA);
transmitting a Multi-User Request to Send (MU-RTS), the MU-RTS comprising a MU-RTS user information field with a plurality of available bits, the plurality of available bits including one or more frame sequence bits of indicating the frame sequence;
receiving one or more Clear to Send (CTS) signals;
transmitting the data signal in response to receiving the CTS; and
receiving one or more acknowledge signals based on the frame sequence.

16. The non-transitory computer-readable medium of claim 15, wherein the plurality of available bits further comprise any one of (i) one or more relay ID bits indicating a relay ID of a relay Station (rSTA), (ii) one or more relay bits indicating the rSTA to act as a relay, (iii) one or more destination ID bits indicating a dSTA ID of the dSTA, (iv) one or more destination bits indicating the dSTA is a destination for the data signal, or (v) any combination of (i)-(iv).

17. The non-transitory computer-readable medium of claim 15, wherein:
transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises:
receiving a rSTA Block Acknowledge (BA) from the rSTA after transmitting the data signal to the rSTA, and
receiving a relay BA from the rSTA after the rSTA sends the data signal to the dSTA and receives a dSTA BA from the dSTA.

18. The non-transitory computer-readable medium of claim 15, wherein:
transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises receiving a relay BA from the rSTA after the rSTA sends the data signal to the dSTA and receives a dSTA BA from the dSTA.

19. The non-transitory computer-readable medium of claim 15, wherein:
transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises:
receiving a rSTA BA from the rSTA after transmitting the data signal to the rSTA, and
receiving a dSTA BA from the dSTA after the rSTA sends the data signal to the dSTA.

20. The non-transitory computer-readable medium of claim 15, transmitting the MU-RTS comprises transmitting the MU-RTS to the rSTA and the dSTA;
receiving the one or more CTS signals comprises receiving a rSTA CTS signal from the rSTA and a dSTA CTS signal from the dSTA;
transmitting the data signal comprises transmitting the data signal to the rSTA; and
receiving the one or more acknowledge signals comprises: receiving a joint BA from the dSTA after the rSTA sends the data signal to the dSTA.
